(19) United States
(12) Patent Application Publication
(10) Pub. No.: US 2012/0157656 A1
(43) Pub. Date: Jun. 21, 2012

(54) POLYALKYLENE GLYCOL-BASED POLYMER AND PROCESS FOR PRODUCING THE SAME

(75) Inventors: Atsuro Yoneda, Osaka (JP); Akiko Hemmi, Osaka (JP); Sachiko Nakanishi, Osaka (JP); Yuki Sano, Osaka (JP)

(73) Assignee: NIPPON SHOKUBAI CO, LTD, Osaka-shi (JP)

(21) Appl. No.: 12/971,340

(22) Filed: Dec. 17, 2010

(51) Int. Cl. C08G 65/34

(52) U.S. Cl. 528/425

(57) ABSTRACT

The present invention has an object to provide a polyalkylene glycol-based polymer that has high anti-soil redeposition ability and high compatibility with surfactants in washing treatment, and a process for producing the same. The present invention is a polyalkylene glycol-based polymer comprising a plurality of added oxyalkylene groups, the polyalkylene glycol-based polymer obtained by polymerizing a polyalkylene glycol-based compound having a structure unit including the oxyalkylene groups at or near a terminal of a molecule and a monomer material including a carboxyl group-containing monomer, under the condition that a mass ratio between the polyalkylene glycol-based compound and the carboxyl group-containing monomer is (95:5) to (60:40), wherein the structure unit including the oxyalkylene groups is represented by the following formula (1);

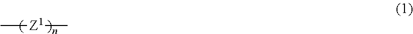

in the formula, each of Z¹s represents a C₃₋₄ oxyalkylene group and may be the same as or different from each other; and n represents an average addition number of moles of the oxyalkylene groups (—Z¹—) and is from 3 to 30.

### TECHNICAL FIELD

The present invention relates to a polyalkylene glycol-based polymer and a process for producing the same, and more specifically to a polyalkylene glycol-based polymer useful as a raw material for detergent additives and the like and a process for producing the same.

### BACKGROUND ART

Polyalkylene glycol-based polymers are useful polymers used in various industrial fields, and have high performance when used, for example, in dispersants, detergent compositions, and the like in aqueous environment. In the case that polyalkylene glycol-based polymers are used in aqueous environment, several influential factors such as the quality of water to be used and the interaction with other materials used in combination should be considered. Specifically, the hardness of water is different among countries or regions, and some of polyalkylene glycol-based polymers that produce various effects in aqueous environment with low water hardness may not produce sufficient effects in aqueous environment with high water hardness. When used, for example, in a detergent composition containing a surfactant, some polyalkylene glycol-based polymers may not have sufficient washing performance depending on the degree of the interaction with the surfactant.

Polymers used for detergents and the like have been known, and one example of such polymers is a graft polymer produced by graft polymerization of a monomer material including 40 to 100 mol % of (meth)acrylic acid and 0 to 60 mol % of another copolymerizable monoethylenic unsaturated monomer on a polyether compound containing ethylene oxide as not less than 80 mol % of structure unit and having a number average molecular weight of not less than 200 (Patent Document 1). The graft polymerization is carried out at a temperature of not lower than 100° C. in the presence of a polymerization initiator and substantially in the absence of a solvent, and the amount of the monomer material is not less than 25% by weight based on the weight of the polyether compound. Patent Document 1 describes that the graft polymer has high compatibility with surfactants and high ability to disperse calcium carbonate and remarkably reduces scale formation.

Another example of such polymers is a graft polymer produced by graft polymerization of a monomer material including 40 to 90 mol % of (meth)acrylic acid and 10 to 60 mol % of an ethylenic unsaturated dicarboxylic acid on a polyether compound containing ethylene oxide as not less than 50 mol % of structure unit and having a number average molecular weight of not less than 200 (Patent Document 2). The amount of the monomer material is not less than 5% by weight and less than 25% by weight based on the weight of the polyether compound, and the graft polymerization is carried out at a temperature of not lower than 120° C. in the present of a polymerization initiator and substantially in the absence of a solvent by the steps of: mixing not less than half of the total amount of the ethylenic unsaturated dicarboxylic acid with the polyether compound; and adding the remaining monomer material and the polymerization initiator so that the compounds are graft polymerized at a temperature not lower than 120° C. Patent Document 2 teaches that the graft polymer has high anti-gelling property and improves washing performance when used in detergents.

Still another example of such polymers is a polymer having a hydroxyl value of not less than 30 mgKOH/g and an acid value of not less than 200 mgKOH/g produced by graft polymerization of a monoethylenic unsaturated monomer material on a polyether compound containing ethylene oxide as not less than 80 mol % of structure unit and having a number average molecular weight of not less than 200 (Patent Document 3). Patent Document 3 teaches that the polymer remarkably reduces scale formation.

In addition to the above examples, Patent Document 4 discloses a polymer produced by graft polymerization of a monoethylenic unsaturated monomer material essentially including an unsaturated carboxylic acid-based monomer on a polyether compound having at least one ethylene oxide repeating unit in the molecular structure and a number average molecular weight of less than 200, in the absence of a solvent. Patent Document 4 teaches that the polymer remarkably reduces scale formation.

Patent Document 5 discloses a graft polymer composition containing two or more graft polymers, wherein a monoethylenic unsaturated monomer material including an unsaturated carboxylic acid-based monomer is graft polymerized on a main chain containing a polyether moiety containing a polyether moiety. The graft polymer composition is characterized in that the difference in the number of carbons in the terminal structure unit in the main chain between any two out of the graft polymers is not less than three under a predetermined condition. Patent Document 5 teaches that the graft polymer composition has high detergent performance and high compatibility with liquid detergents.

Patent Document 6 discloses a hydrophilic graft polymer produced by graft polymerization of a monomer material including an unsaturated monocarboxylic acid on a polyalkylene oxide. The hydrophilic graft polymer is characterized in that the molar ratio of the side chain moiety derived from the unsaturated monocarboxylic acid is more than 90 mol % relative to all side chains, and that the remaining amount of the unsaturated monocarboxylic acid is less than 200 ppm by mass relative to the total mass of the hydrophilic graft polymer. Patent Document 6 teaches that the hydrophilic graft polymer has good temporal storage stability of the molecular weight.

Patent Document 7 discloses a hydrocarbon-containing graft polymer produced by graft polymerization of a monomer material including a hydrophilic monomer having an anionic or hydroxyl group on a polyoxyalkylene-based compound having a specific structure including a C₁₀₋₂₀ alkyl or alkenyl group at the end. Patent Document 7 teaches that the graft polymer suppresses precipitation of surfactants well and has good anti-soil redeposition ability in washing treatment.

Patent Document 8 discloses a polymer composition produced by polymerizing a polyoxyalkylene-based compound and an acid group-containing unsaturated monomer in the presence of a polymerization initiator. The polymer composition is characterized in that the polyoxyalkylene-based compound has an oxyalkylene group and at least one of a C₈ or higher aryl group, a C₈ or higher alkyl group and a C₈ or higher alkenyl group, that a structure unit derived from the oxyalkylene group is contained in an amount of 10 to 50 mol per mol of the polyoxyalkylene-based compound, that the mass ratio between a structure unit derived from the polyoxyalkylene-based compound and a structure unit derived from the acid group-containing unsaturated monomer is (95:5) to (80:20), and that the polymer composition includes a specific compound derived from the initiator. Patent Document 8 teaches that the polymer composition remarkably suppresses precipitation of surfactants in washing treatment.

Patent Document 9 discloses a copolymer produced by graft polymerization of acrylic acid on a polyoxyalkylene compound including ethylene oxide and propylene oxide. Patent Document 9 teaches that copolymers that are substantially free from homopolymers of acrylic acid can be produced by separately adding 3 to 15% by weight, based on the weight of the charged polyoxyalkylene compound, of acrylic acid and a catalytic amount of a specific initiator to the polyoxyalkylene compound under stirring.

### CITATION LIST

### Patent Document

Patent Document 1: Japanese Patent Publication (Kokai) No. H07-53645
Patent Document 2: Japanese Patent Publication (Kokai) No. H08-208769
Patent Document 3: Japanese Patent Publication (Kokai) No. H10-192891
Patent Document 4: Japanese Patent Publication (Kokai) No. H11-171939
Patent Document 5: Japanese Patent Publication (Kokai) No. 2002-332391
Patent Document 6: WO2008/020556
Patent Document 7: Japanese Patent Publication (Kokai) No. 2007-254679
Patent Document 8: Japanese Patent Publication (Kokai) No. 2009-256656
Patent Document 7: U.S. Pat. No. 4,528,334

### SUMMARY OF THE INVENTION

### Problems to be Solved by the Invention

As described above, polymers of various structures for detergents are under examination.

Nowadays, there is a water saving trend in washing treatment (e.g. use of used water in bathtub for washing treatment) with recent growing concern of consumers for environmental problems. The use of used water in bathtub for washing treatment has disadvantages such as attachment of soil components in the water to fibers in washing treatment, and condensed hardening components in the water caused by heating the water several times. Therefore, the required level of performance of preventing soil components from reattaching to fibers (referred to as anti-soil redeposition ability) in washing treatment using water with a higher hardness is much higher than before. The above polymers, however, do not sufficiently meet the recent needs, that is, high performance levels in aqueous environment, and therefore should be further revised so that polymers that meet the recent needs and are suitably used as higher-performance detergent additives are provided.

Considering the above-described background, the present invention aims to provide a polyalkylene glycol-based polymer having high anti-soil redeposition ability in washing treatment, and high compatibility with surfactants, and a process for producing the same.

### Means for Solving the Problems

The present inventor examined various polymers suitably used as detergent additives and the like. The examination revealed that a polyalkylene glycol-based polymer produced by polymerizing monomer materials including a polyalkylene glycol-based compound having a specific average addition number of moles of C₃₋₄ oxyalkylene groups and a carboxyl group-containing monomer has strikingly high anti-soil redeposition ability and high compatibility with surfactants even in water with high hardness. Furthermore, the present inventor found that the use of the monomer material including these monomers at ratios within a specific range further improves the above performance and property, and that such a polymer is suitably used as a detergent additive that meets the recent needs. Thus, the present inventor found a way to solve the above-described problems and completed the present invention.

Specifically, the present invention provides a polyalkylene glycol-based polymer comprising a plurality of added oxyalkylene groups, the polyalkylene glycol-based polymer obtained by polymerizing a polyalkylene glycol-based compound having a structure unit including the oxyalkylene groups at or near a terminal of a molecule and a monomer material including a carboxyl group-containing monomer, under the condition that a mass ratio between the polyalkylene glycol-based compound and the carboxyl group-containing monomer is (95:5) to (60:40), wherein the structure unit including the oxyalkylene groups is represented by the following formula (1);

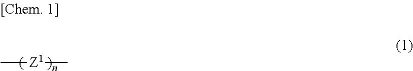

in the formula (1), each of Z¹s represents a C₃₋₄ oxyalkylene group and may be the same as or different from each other; and n represents an average addition number of moles of the oxyalkylene groups (—Z¹—) and is from 3 to 30.

Another aspect of the present invention is a process for producing a polyalkylene glycol-based polymer a plurality of added oxyalkylene groups, the process comprising polymerizing a polyalkylene glycol-based compound having a structure unit including the oxyalkylene groups at or near a terminal of a molecule and a monomer material including a carboxyl group-containing monomer, under the condition that a mass ratio between the polyalkylene glycol-based compound and the carboxyl group-containing monomer is (95:5) to (60:40), wherein the structure unit including the oxyalkylene groups is represented by the following formula (1);

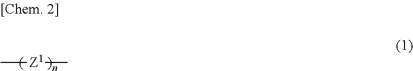

in the formula (1), each of Z¹s represents a C₃₋₄ oxyalkylene group and may be the same as or different from each other; and n represents an average addition number of moles of the oxyalkylene groups (—Z¹—) and is from 3 to 30.

Hereinafter, the present invention is described in more detail.

### [Polyalkylene Glycol-Based Polymer]

### <Polyalkylene Glycol-Based Compound>

The polyalkylene glycol-based polymer of the present invention is obtained by polymerizing a polyalkylene glycol-based compound having a structure unit represented by the formula (1) at or near a terminal of a molecule and a monomer material including a carboxyl group-containing monomer in the mass ratio between the polyalkylene glycol-based compound and the carboxyl group-containing monomer of (95:5) to (60:40).

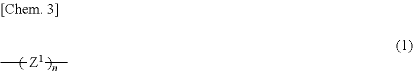

In the formula, each of Z¹s represents a C₃₋₄ oxyalkylene group and may be the same as or different from each other; and n represents an average addition number of moles of the oxyalkylene groups (—Z¹—) and is from 3 to 30.

Here, it is important that n is always not less than 3. With a structure in which n is not less than 3, the polyalkylene glycol-based polymer of the present invention is likely to produce favorable interaction with soil components and to have improved anti-soil redeposition ability when used, for example, as a detergent additive. On the other hand, if n is more than 30, the yield of the polyalkylene glycol-based polymer of the present invention will be low, and therefore the anti-soil redeposition ability will be low. More preferably, n is 3 to 15, further more preferably 3 to 10, and still further more preferably 3 to 5.

In the present invention, the term “polyalkylene glycol-based polymer” is intended to include polymers having a polyalkylene glycol chain. The term “polyalkylene glycol-based compound” is similarly intended to include compounds having a polyalkylene glycol chain.

The polyalkylene glycol-based compound, which is a material for the polyalkylene glycol-based polymer of the present invention, has one or more structure units represented by the formula (1). The polyalkylene glycol-based compound preferably has one or two structure units represented by the formula (1) in one molecule, and more preferably one structure unit represented by the formula (1) in one molecule.

The polyalkylene glycol-based compound preferably has a C₃₋₄ oxyalkylene structure unit at or near a terminal of a molecule, and particularly preferably has the structure unit at an end. With the structure unit at or near a terminal of a molecule, the polyalkylene glycol-based polymer is likely to adsorb on soil particles well and has improved anti-soil redeposition ability.

The polyalkylene glycol-based compound is not particularly limited, provided that it has the structure unit represented by the formula (1). Specifically, examples thereof include compounds having a structure represented by the formula (2):

[Chem. 4]

R²Y—Xₚ—Z_{q}—OR¹)ᵣ (2)

wherein R¹ and R² each represent H, a C₆₋₂₀ aryl, or a linear or branched C₁₋₂ alkyl, or alkenyl group; the number of R¹s in the molecular structure is r, and each of R¹s may be the same as or different from each other; X and Y are described below; Z represents an oxyalkylene group; p is 0 or 1; q is an average addition number of moles of the oxyalkylene groups and is 9 to 150; and r is an integer of 1 to 6. Zq includes a structure having, in average, 3 to 30 added C₃₋₄ oxyalkylene groups.

In the formula (2), R¹ is preferably H or a C₆₋₁₈ aryl or a C₁₋₁₈ alkyl or alkenyl group, more preferably H or a C₆₋₁₂ aryl or a C₁₋₁₂ alkyl or alkenyl group, further more preferably H or a C₆ aryl or a C₁₋₆ alkyl or alkenyl group, and most preferably H. When each of R¹ is selected from these preferable examples, the anti-soil redeposition ability of the polyalkylene glycol-based polymer of the present invention is likely to be improved. In addition, the polyalkylene glycol-based compound has viscosity suitable for polymerization and will facilitate the polymerization.

R² is more preferably H or a C₁₋₃ alkyl group. With these structures at R², the structure represented by the formula (2) will suitably adsorb on soil matters and the like when the polyalkylene glycol-based polymer is used, for example, as a detergent additive. R² is particularly preferably a C₁₋₃ alkyl group, and more particularly preferably a methyl or ethyl group. With these structures, the molecular structure of the polyalkylene glycol-based polymer will be suitably controlled and the polyalkylene glycol-based polymer will suitably adsorb on soil matters and the like.

The polyalkylene glycol-based polymer of the present invention is a graft polymer in which polymer chains derived from the carboxyl group-containing monomer are linked to carbon atoms in the polyoxyalkylene chain of the polyalkylene glycol-based compound. Hereinafter, the polyalkylene glycol-based polymer of the present invention is also referred to as the graft polymer of the present invention.

The graft polymer of the present invention is preferably free from aromatic rings in the molecular structure. This is because, if the graft polymer of the present invention has aromatic rings, the aromatic rings will become a part of harmful substances when the graft polymer of the present invention is released to the natural environment and decomposed. Considering this fact, R¹ and R² are preferably H or an alkyl or alkenyl group. To ensure comparatively low viscosity and good handleability, R¹ and R² are preferably H or a secondary alkyl or alkenyl group.

Examples of the alkyl groups include methyl group, ethyl group, propyl group, butyl group, 2-ethylhexyl group, octyl group, nonyl group, decyl group, undecyl group, dodecyl group, tridecyl group, tetradecyl group, pentadecyl group, hexadecyl group, heptadecyl group, octadecyl group, nonadecyl group, and icosyl group.

Examples of the alkenyl groups include octylene group, nonylene group, decylene group, undecylene group, dodecylene group, tridecylene group, tetradecylene group, pentadecylene group, hexadecylene group, heptadecylene group, octadecylene group, nonadecylene group, and icosylene group.

Among these, R¹ and R² are each preferably a 2-ethylhexyl group, dodecyl group, tridecyl group, tetradecyl group, dodecylene group, tridecylene group, or tetradecylene group, and more preferably a 2-ethylhexyl group, dodecyl group, tridecyl group, or tetradecyl group. To avoid gelation of the polymer, R¹ and R² are more preferably a group other than alkenyl groups although C₄ or higher alkenyl groups are preferable among alkenyl groups.

Examples of the aryl groups include phenyl group, phenethyl group, 2,3- and 2,4-xylyl groups, mesityl group, naphthyl group, anthryl group, phenanthryl group, biphenyl group, trithyl group, and pyrenyl group. Among these, phenethyl group, 2,3- and 2,4-xylyl groups, and naphthyl group are preferable and phenethyl group and 2,3- and 2,4-xylyl groups are more preferable. To avoid impurities of low-molecular weight aromatic compounds, R¹ and R² are each preferably a group other than aryl groups.

In the formula (2), X is one selected from the structures shown below.

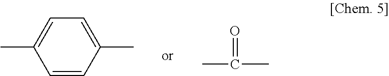

In the formula (2), p is 0 or 1. As described above, the graft polymer of the present invention is preferably free from aromatic rings. Accordingly, when p is 1, X is preferably a carbonyl group. However, p is more preferably 0 (i.e. X is not present.)

In the formula (2), Y is one selected from the structures shown below.

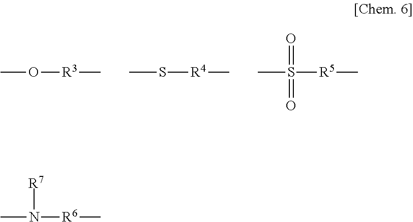

wherein R³ to R⁶ independently represent a C₂₋₆ alkylene group, preferably a C₂₋₄ alkylene group, more preferably a C₂₋₃ alkylene group, and furthermore preferably a C₂ alkylene group; and R⁷ represents H or a group represented by the formula (3):

[Chem. 7]

—R⁸—Z_{q}—R⁹ (3)

wherein R⁸ represents a C₂₋₆ alkylene group, preferably a C₂₋₄ alkylene group, more preferably a C₂₋₃ alkylene group, and further more preferably a C₂ alkylene group; R⁹ represents H or a C₆₋₂₀ aryl or a C₁₋₂₀ alkyl or alkenyl group; and Z and q are defined as in the formula (2). To improve the anti-soil redeposition ability, Y is preferably —O—R³—.

In the formula (2), Z represents an oxyalkylene group. Zq in the formula (2) includes a structure having, in average, 3 to 30 added C₃₋₄ oxyalkylene groups. The number of carbon atoms in oxyalkylene groups other than the C₃₋₄ oxyalkylene groups is 2 to 20, preferably 2 to 15, more preferably 2 to 10, further more preferably 2 to 5, still further more preferably 2 or 3, and particularly preferably 2. Examples of the oxyalkylene groups include groups derived from compounds such as ethylene oxide (EO), propylene oxide (PO), isobutylene oxide, 1-buthene oxide, 2-buthene oxide, trimethylethylene oxide, tetramethylene oxide, tetramethylethylene oxide, butadiene monoxide, octylene oxide, styrene oxide, and 1,1-diphenylethylene oxide. Among these, Z is preferably a group derived from EO or PO (i.e. oxyethylene group or oxypropylene group), and more preferably an oxyethylene group. Zs may be of the same structure or may be of two or more different structures.

In the formula (2), q is an average addition number of moles of the oxyalkylene groups (Z) and is from 9 to 150, preferably 9 to 99, more preferably 9 to 80, further more preferably 12 to 70, and still furthermore preferably 15 to 60. If q is less than 9, the polymerization may not proceed. In this case, the water solubility of the polymer is low, which in turn may lead to low anti-soil redeposition ability. If q is more than 150, the viscosity is high and the polymerization may not proceed. Even if the polymerization proceeds, the resulting polymer may not be used as a builder. With larger q, the yield of the graft polymer will be higher, that is, the amount of unreacted polyalkylene glycol-based compound will be smaller.

Preferably, the structure (Z_{q}) constituted by the oxyalkylene groups in the formula (2) is mainly composed of oxyethylene groups (—O—CH₂—CH₂—). In this case, the term “mainly composed of oxyethylene groups” means that oxyethylene groups constitute not less than half of all the oxyalkylene groups. This structure produces advantageous effects, that is: the polymerization smoothly proceeds in the production process; and the water solubility and anti-soil redeposition ability are improved. When Z_{q} in the formula (2) are mainly composed of oxyethylene groups, the molar ratio (mol %) of the oxyethylene groups in all the oxyalkylene groups (100 mol %) is 50 to 100 mol %. With less than 50 mol % of oxyethylene groups, the group constituted by the oxyalkylene groups has low hydrophilicity. The molar ratio is more preferably not less than 60 mol %, further more preferably not less than 70 mol %, and still further more preferably not less than 75 mol %, and particularly preferably not less than 80 mol %.

In the formula (2), r is an integer of 1 to 6. When r is not less than 2, the polyalkylene glycol-based compound represented by the formula (2) has a structure in which each of the parenthesized groups in the formula (2) is linked to a carbon atom in the group R². This does not mean that the polyalkylene glycol-based compound includes a repeating structure having the parenthesized groups in the formula (2) as repeating units. Each of the parenthesized groups of the formula (2) may be the same as or different from each other, and r is preferably 1 to 4, more preferably 1 or 2, and further more preferably 1.

As described above, the polyalkylene glycol-based compound preferably includes the structure represented by the formula (1) at or near a terminal of a molecule, and particularly preferably at a terminal of a molecule. For example, the structure —Z_{q}—OR′ in the formula (2) can be represented by the formula (4) below. In the formula (4), when the polyalkylene glycol-based compound has the structure unit represented by the formula (1) at an end, m is 0 and R¹ is H. In the formula (4), when the polyalkylene glycol-based compound has the structure unit represented by the formula (1) near a terminal of a molecule, (i) m is from 1 to 3, or (ii) m is 0 and R¹ is a group other than H.

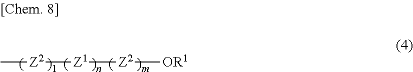

In the formula (4), R¹ represents H or a C₆₋₂₀ aryl or a C₁₋₂₀ alkyl or alkenyl group; Z¹ represents a C₃₋₄ oxyalkylene group; Z² represents a C₂₋₂₀ oxyalkylene group; n is an average addition number of moles of the oxyalkylene groups (—Z¹—) and is from 3 to 30; the sum of l, n, and m is from 9 to 150; and m is preferably 0.

The polyalkylene glycol-based compound of the present invention preferably contains the structure represented by the formula (4).

The polyalkylene glycol-based compound used in the present invention may be a commercially available product or may be prepared. The polyalkylene glycol-based compound can be prepared by adding the above-described alkylene oxides to compounds including a structure to be a hydrocarbons moiety of the polyalkylene glycol-based compound such as alcohols, esters, amines, amides, thiols, and sulfonic acids, for example, by the techniques: 1) anion polymerization using strong alkalis such as hydroxides of alkali metals and alkoxides or alkylamines as base catalysts; 2) cationic polymerization using halides of metals or semimetals, mineral acids, or acetic acid as catalysts; and 3) coordination polymerization using alkoxides of metals such as aluminum, iron, and zinc, alkaline-earth metals, Lewis acids, and the like in combination. Examples of the polyalkylene glycol-based compound include polyethylene glycol, methoxy polyethylene glycol, butoxy polyethylene glycol, and phenoxy polyethylene glycol.

### <Carboxyl Group-Containing Monomer (B)>

Typically, the carboxyl group-containing monomer is graft polymerized to form a chain graft polymerized on a carbon atom in the polyoxyalkylene chain of the polyalkylene glycol-based polymer of the present invention.

In the present invention, the carboxyl group-containing monomer (hereinafter, also referred to as the monomer (B)) is a monomer essentially containing 1) an unsaturated double bond and 2) a carboxyl group and/or a salt thereof. Specific examples thereof include unsaturated monocarboxylic acids such as acrylic acid, methacrylic acid, crotonic acid, α-hydroxyl acrylic acid, and α-hydroxyl methylacrylic acid, and derivatives thereof, and salts of these monomers; and unsaturated dicarboxylic acids such as itaconic acid, fumaric acid, maleic acid, citraconic acid, and 2-methylene glutaric acid, and salts thereof. Any unsaturated dicarboxylic acid-based monomer may be used, provided that it contains a single unsaturated group and two carboxyl groups in the molecular structure. Suitable examples thereof include maleic acid, itaconic acid, citraconic acid, and fumaric acid; monovalent metal salts, divalent metal salts, ammonium salts, and organic ammonium salts (organic amine salts) of the above acids; and anhydrides of the above examples.

Among these examples, the carboxyl group-containing monomer (B) is preferably acrylic acid, an acrylate, maleic acid, or a maleate because they remarkably improve the anti-soil redeposition ability of the resulting polymer. It is more preferable to essentially use acrylic acid or an acrylate.

Suitable examples of salts of the unsaturated monocarboxylic acids and unsaturated dicarboxylic acids include metal salts, ammonium salts, and organic amine salts.

Examples of the metal salts include monovalent alkali metal salts such as sodium salts, lithium salts, and potassium salts; alkaline-earth metal salts such as magnesium salts and calcium salts; and salts of other metals such as aluminum salts andiron salts.

Examples of the organic amine salts include alkanolamine salts such as monoethanolamine salts, diethanolamine salts, and triethanolamine salts; alkylamine salts such as monoethylamine salts, diethylamine salts, and triethylamine salts; organic amine salts such as polyamines including ethylenediamine salts and triethylenediamine salts.

Ammonium salts, sodium salts, and potassium salts are preferable among these because they remarkably improve the anti-soil redeposition ability of the resulting polymer. Sodium salts are more preferable.

In addition to the above examples, examples of the carboxyl group-containing monomer (B) include half esters of unsaturated dicarboxylic acid-based monomers and C₁₋₂₂ alcohols, half amides of unsaturated dicarboxylic acid-based monomers and C₁₋₂₂ amines, half esters of unsaturated dicarboxylic acid-based monomers and C₂₋₄ glycols, and half amides of maleamic acid and C₂₋₄ glycols.

The carboxyl group-containing monomers (B) used to produce the polymer of the present invention may all be of the same structure or may be of two or more different structures.

### <Other Monomer>

In addition to the polyalkylene glycol-based compound and the carboxyl group-containing monomer (B), other monomer(s) (E) may be used to produce the polyalkylene glycol-based polymer of the present invention. The other monomer(s) (E) are not particularly limited and are appropriately selected to provide desired effects.

Specific examples of the other monomer(s) (E) include: sulfonic acid group-containing monomers such as vinylsulfonic acid, (meth)allyl sulfonic acid, isoprenesulfonic acid, 3-allyloxy-2-hydroxypropanesulfonic acid, and acrylamido-2-methylpropanesulfonic acid, and salts of these; dialkylaminoalkyl(meth)acrylates such as dimethylaminoethyl acrylate, dimethylaminoethyl methacrylate, and dimethylaminopropyl acrylate; dialkylaminoalkyl (meth)acrylamides such as dimethylaminoethyl acrylamide, dimethylaminoethyl methacrylamide, and dimethylaminopropyl acrylamide; amino group-containing monomers such as vinylimidazole, vinylpyridin, diallylalkylamines, and diallyl amine, and quaternized compounds of these; N-vinyl monomers such as N-vinylpyrrolidone, N-vinylformamide, N-vinylacetamide, N-vinyl-N-methylformamide, N-vinyl-N-methylacetamide, and N-vinyloxazolidone; amide-containing monomers such as (meth)acrylamide, N,N-dimethylacrylamide, and N-isopropylacrylamide; hydroxyl group-containing monomers such as (meth)allyl alcohol and isoprenol; alkyl(meth)acrylate-based monomers such as butyl(meth)acrylate, 2-ethylhexyl(meth)acrylate, and dodecyl(meth)acrylate; hydroxyalkyl(meth)acrylate-based monomers such as hydroxyethyl(meth)acrylate, 2-hydroxyethyl(meth)acrylate, hydroxybutyl(meth)acrylate, 2-hydroxybutyl(meth)acrylate, 4-hydroxybutyl(meth)acrylate, α-hydroxymethylethyl(meth)acrylate, hydroxypentyl(meth)acrylate, hydroxyneopentyl(meth)acrylate, and hydroxyhexyl(meth)acrylate; vinylaryl monomers such as styrene, indene, and vinylaniline; and other monomers such as isobutylene, and vinyl acetate.

The quaternized compounds can be obtained by the reaction between the amino group-containing monomers and common quaternizing agents. Examples of the quaternizing agents include alkyl halides and dialkyl sulfates. The exemplified salts include chlorides and organic acid salts.

In the case that the optional monomer(s) (E) are used to produce the polyalkylene glycol-based polymer of the present invention, the monomers (E) may all be of the same structure or may be of two or more different structures.

The carboxyl group-containing monomer (B) and other monomer(s) (E) may be added in any fashion such as a random fashion or a block fashion. Alternatively, the carboxyl group-containing monomer (B) and other monomer(s) (E) may separately form different polymerization chains added to the polymer. Hereinafter, the carboxyl group-containing monomer (B) and other monomer(s) (E) are together referred to as a “monomer material”.

The ratio of the carboxyl group-containing monomer in the monomer material is preferably 80 to 100 mol %, more preferably 90 to 100 mol %, further more preferably 95 to 100 mol %, and still further more preferably 100 mol % based on 100 mol % of all the monomers (the carboxyl group-containing monomer and other monomer(s)). At ratios within the above range, the anti-soil redeposition ability of the polyalkylene glycol-based polymer of the present invention is likely to be remarkably improved. The ratio of the other monomer(s) in the monomer material is preferably 0 to 20 mol %, more preferably 0 to 10 mol %, further more preferably 0 to 5 mol %, and still further more preferably 0% based on 100 mol % of all the monomers.

The polyalkylene glycol-based polymer of the present invention is produced from the polyalkylene glycol-based compound and the monomer material including the carboxyl group-containing monomer and optionally including the other monomer(s), and the ratio between the amounts of the carboxyl group-containing monomer and the polyalkylene glycol-based compound is determined as follows: The ratio of the amount of the carboxyl group-containing monomer is 5 to 40% by mass based on 100% by mass of the total amount of the carboxyl group-containing monomer and the polyalkylene glycol-based compound. The polyalkylene glycol-based polymer of the present invention is produced by polymerizing the polyalkylene glycol-based compound and the monomer material essentially including the carboxyl group-containing monomer under the condition that the mass ratio between the polyalkylene glycol-based compound and the carboxyl group-containing monomer is (95:5) to (60:40). The ratio of the amount of the carboxyl group-containing monomer to the total amount of the carboxyl group-containing monomer and the polyalkylene glycol-based compound is more preferably 6 to 30% by mass, further more preferably 10 to 25% by mass, and still furthermore preferably 15 to 22% by mass. At ratios within the above range, the anti-soil redeposition ability of the polyalkylene glycol-based polymer of the present invention is likely to be remarkably improved.

The ratio between the amounts of the monomer material and the polyalkylene glycol-based compound is determined as follows: the ratio of the monomer material is preferably 5 to 40% by mass, more preferably 6 to 30% by mass, further more preferably 10 to 25% by mass, and still further more preferably 15 to 22% by mass based on 100% by mass of the total amount of the monomer material and the polyalkylene glycol-based compound (also referred to as all the materials).

The mass ratios (% by mass) of acid group-containing monomers including the carboxyl group-containing monomer (B) to all the materials are determined by treating these materials as the respective corresponding acids. For example, in the case of sodium acrylate, the mass ratio of the corresponding acid, acrylic acid, is calculated. The mass ratios (% by mass) of structure units derived from the acid group-containing monomers to all the structure units derived from all the materials are also similarly calculated.

Acid group-containing unsaturated monomers in a composition containing the polyalkylene glycol-based composition of the present invention, which is described below, can be quantified by liquid chromatography under the following conditions.

Measuring device: L-7000 series (product of Hitachi Ltd.)

Detector: UV detector, L-7400 (product of Hitachi Ltd.)

Column: SHODEX RSpak DE-413 (product of Showa Denko K. K.)

Temperature: 40.0° C.

Eluant: 0.1% phosphoric acid aqueous solution

Flow velocity: 1.0 ml/min

The weight average molecular weight of the polyalkylene glycol-based polymer of the present invention is not particularly limited and can be appropriately determined, considering desired performance such as desired performance for a detergent builder. Specifically, the weight average molecular weight of the graft polymer of the present invention is preferably 300 to 50000, more preferably 500 to 30000, further more preferably 1000 to 20000, and still further more preferably 1000 to 5000. With too high weight average molecular weight, the graft polymer of the present invention will have too high viscosity and therefore will be difficult to handle. With too low weight average molecular weight, the anti-soil redeposition ability may not be provided. The weight average molecular weight of the graft polymer of the present invention used herein is determined by the technique described in Examples below.

The number average molecular weight of the graft polymer of the present invention is not particularly limited and can be appropriately determined, considering desired performance such as desired performance for a detergent builder. Specifically, the number average molecular weight of the graft polymer of the present invention is preferably 300 to 25000, more preferably 350 to 15000, further more preferably 500 to 10000, and still further more preferably 500 to 3000. With too high number average molecular weight, the graft polymer of the present invention will have high viscosity and therefore will be difficult to handle. With too low number average molecular weight, the anti-soil redeposition ability may not be provided. The number average molecular weight of the graft polymer of the present invention used herein is determined by the technique with the device under the conditions described in Examples below.

The polyalkylene glycol-based polymer of the present invention has high anti-soil redeposition ability. The anti-soil redeposition ratio of the polyalkylene glycol-based polymer is preferably not less than 55%, more preferably not less than 60%, and further more preferably not less than 65%.

The anti-soil redeposition ratio can be measured by the procedure described in Examples below.

### [Polymer Composition]

The polyalkylene glycol-based polymer of the present invention may be present with other component(s) in a polyalkylene glycol-based polymer composition. Examples of components other than the polyalkylene glycol-based polymer of the present invention include graft polymers produced by graft polymerization of the polyalkylene glycol-based compound with the carboxyl group-containing monomer and/or the other monomer(s), unreacted polyalkylene glycol-based compound, by-products derived from the carboxyl group-containing monomer, the carboxyl group-containing monomer, unreacted polymerization initiators, decomposed compounds of polymerization initiators, and polymers of the carboxyl group-containing monomer.

Hereinafter, such a composition containing the polyalkylene glycol-based polymer of the present invention is referred to as a polymer composition of the present invention.

The mass ratio between structure units derived from the polyalkylene glycol-based compound and structure units derived from the carboxyl group-containing monomer in the polymer composition of the present invention is preferably (95:5) to (60:40), more preferably (94:6) to (70:30), further more preferably (92:8) to (75:25), and still further more preferably (90:10) to (80:20). If the amount of the structure units derived from the carboxyl group-containing monomer is too small, the anti-soil redeposition ability is likely to be low. If the amount of the structure units derived from the carboxyl group-containing monomer is too large, the resulting composition tends to contain large amounts of impurities derived from the carboxyl group-containing monomer. In this case, the temporal stability and detergent performance of the composition are likely to be low. Accordingly, the ratio is preferably within the above range.

The “structure units derived from the polyalkylene glycol-based compound” are intended to include structure units derived from the polyalkylene glycol-based compound in the polyalkylene glycol-based polymer of the present invention and unreacted polyalkylene glycol-based compound (and structure units derived from the polyalkylene glycol-based compound in by-products if they are produced.) Namely, the total mass of the structure units derived from the polyalkylene glycol-based compound is equal to the mass of the polyalkylene glycol-based compound used in the polymerization. The “structure units derived from carboxyl group-containing monomer” are similarly intended to include structure units derived from the carboxyl group-containing monomer in the polyalkylene glycol-based polymer of the present invention, unreacted carboxyl group-containing monomer, structure units in polymers of the carboxyl group-containing monomer and structure units in polymers of the carboxyl group-containing monomer and other monomers. The total mass of the structure units derived from the carboxyl group-containing monomer is equal to the mass of the carboxyl group-containing monomer used in the polymerization.

These structure units can be analyzed by techniques such as NMR.

Specific polymerization initiator(s) described later are preferably used for the production of the polyalkylene glycol-based polymer in the present invention to reduce unreacted polyalkylene glycol-based compound. Specifically, the amount of reacted polyoxyalkylene glycol-based compound is preferably 45 to 100 parts by mass, more preferably 50 to 100 parts by mass, and further more preferably 55 to 100 parts by mass based on 100 parts by mass of the total of reacted polyoxyalkylene glycol-based compound and unreacted polyoxyalkylene glycol-based compound (100 parts by mass of the polyoxyalkylene glycol-based compound added in the reaction system). The amount of reacted polyoxyalkylene glycol-based compound can be calculated from the amount the unreacted polyoxyalkylene glycol-based compound that can be quantified by high-speed liquid chromatography under the following conditions.

Measuring device: 8020 series (product of Tosoh Corp.)

Column: CAPCELL PAK C1 UG120 (product of Shiseido Co., Ltd.)

Temperature: 40.0° C.

Eluant: dodecahydrate solution of 10 mmol/L disodium hydrogen phosphate (pH 7 (controlled with phosphoric acid))/acetonitrile=45/55 (volume ratio)

Flow velocity: 1.0 ml/min

Detector: RI, UV (detection wavelength: 215 nm)

The “polymer composition” used herein is not particularly limited and, in view of production efficiency, is preferably produced without steps such as a purification step for removing impurities. The polymer composition of the present invention has a low remaining polyoxyalkylene glycol-based compound content and a high graft polymer (graft compound) content. Owing to these properties, the polymer composition effectively improves the anti-soil redeposition ability when used in a detergent. The polymer composition may be diluted with a small amount of water (1 to 400% by mass of water to the composition) after the polymerization step to improve the handleability, and such diluted compositions are also included in the “polymer composition” used in the context of the present application. The yield of the graft compound can be determined from the value calculated by the graft compound yield calculation method described below.

The polymer composition of the present invention may contain at least one of the compounds 1 to 3 represented by the formulae below. These compounds are derived from the above-mentioned specific polymerization initiators.

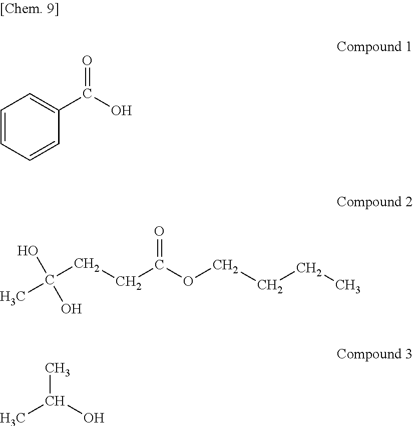

As described below, these compounds are decomposed compounds from the polymerization initiators that are suitably used in the production of the graft polymer. In the case that t-butylperoxy benzoate (hereinafter, also referred to as PBZ) is used, the resulting polymer composition may contain the compound 1. In the case that t-butylperoxyisopropyl monocarbonate (hereinafter, also referred to as PBI) is used as a polymerization initiator, the resulting polymer composition may contain the compound 3. In the case that n-butyl 4,4-di(t-butylperoxy)valerate (hereinafter, also referred to as PHV) is used, the resulting polymer composition may contain the compound 2.

Any one of the polymerization initiators may be used alone, or two or more of the polymerization initiators may be used in combination. Therefore, the polymer composition of the present invention may contain two or more of the compounds 1 to 3.

The amount of the compounds 1 to 3 in the polymer composition preferably constitutes 0.01 to 2.0% by mass of the polymer composition (based on solids content). The presence of the compounds 1 to 3 in an amount within the above range indicates that the polymerization initiator(s) are used in an appropriate amount, and that the resulting composition contains the high-performance graft polymer. The amount of the compounds 1 to 3 means the total amount of the compounds 1 to 3 when two or more of the compounds 1 to 3 are contained. The amount of the compounds 1 to 3 in the composition is determined by high-speed liquid chromatography under the following conditions.

Measuring device: 8020 series (product of Tosoh Corp.)

Column: CAPCELL PAK C1 UG120 (product of Shiseido Co., Ltd.)

Temperature: 40.0° C.

Eluant (compounds 1, 3): dodecahydrate solution of 10 mmol/L disodium hydrogen phosphate (pH 7 (controlled with phosphoric acid))/acetonitrile=90/10 (volume ratio)

Eluant (compound 2): dodecahydrate solution of 10 mmol/L disodium hydrogen phosphate (pH 7 (controlled with phosphoric acid))/acetonitrile=30/70 (volume ratio)

Flow velocity: 1.0 ml/min

Detector: RI, UV (detection wavelength: 215 nm)

The amount of the compounds 1 to 3 in the polymer composition is preferably 0.3 to 20 parts by mass, more preferably 1 to 10 parts by mass, and furthermore preferably 1 to 5 parts by mass based on 100 parts by mass of the carboxyl group-containing monomer used as a material. The presence of the compounds 1 to 3 in an amount within the above range means that the polymerization initiator(s) are used in an appropriate amount, and that the composition contains the graft polymer with high anti-soil redeposition ability.

### [Production Process]

The polyalkylene glycol-based polymer of the present invention is produced by the production process including a step of polymerizing the polyalkylene glycol-based compound and the monomer material essentially including the carboxyl group-containing monomer under the condition in which the mass ratio between the polyalkylene glycol-based compound and the carboxyl group-containing monomer is (95:5) to (60:40). The production process of the present invention may include other steps, provided that it includes the above polymerization step.

The polymerization step can be carried out in the presence of polymerization initiator(s) known in the art. Organic peroxide polymerization initiators are preferably used, and organic peroxide polymerization initiators whose half-life at 135° C. is 6 to 60 minutes are more preferably used.

The use of organic peroxide polymerization initiators allows graft polymerization of the monomer material to the polyalkylene glycol-based compound to smoothly proceed and therefore improves the yield of the graft polymer. The use of organic peroxide polymerization initiators whose half-life at 135° C. is 6 to 60 minutes further improves the yield of the graft polymer.

The “half-life at 135° C.” used herein can be determined in the manner described in “organic peroxide catalogue, 10th edition” (NOF Corporation), and is specifically determined as follows: preparing a 0.1 mol/L or 0.05 mol/L polymerization initiator solution by dissolving a polymerization initiator in a comparatively inert solvent (e.g. benzene); charging the solution in a glass tube under nitrogen atmosphere; sealing the glass tube; and immersing the glass tube in a constant-temperature tank kept at 135° C. to pyrolytically decompose the polymerization initiator. Thus, the time until the polymerization initiator concentration becomes half of the initial concentration can be determined.

For higher handleability, the polymer composition may be typically stored after diluted with a small amount of water. Therefore, the production process of the polymer of the present invention may include a step of diluting the polymer composition after the polymerization.

In the present invention, the polymer composition can be produced by appropriately relying on the common technical knowledge in the art to which the present invention belongs. In the present invention, however, the materials are preferably polymerized substantially by bulk polymerization. Specifically, the polymerization is carried out in a graft polymerization reaction system in which the solvent constitutes not more than 10% by mass of the whole reaction system. A specific procedure in the polymerization method is not particularly limited. Specifically, the polymerization may be performed by appropriately relying on the common technical knowledge relating to bulk polymerization, and optionally, a modified method may be performed. It is preferable to produce the graft compound substantially by bulk polymerization because the yield of the graft compound thus produced is higher compared to the case where aqueous solution polymerization is employed, and the anti-soil redeposition ability is remarkably improved.

The polymerization initiator(s) used to produce the polyalkylene glycol-based polymer of the present invention are preferably organic peroxide(s). Examples thereof include ketone peroxides such as cyclohexanone peroxide, methyl ethyl ketone peroxide, methylcyclohexanone peroxide, methyl acetoacetate peroxide, and 3,3,5-trimethylcyclohexanone peroxide; peroxyketals such as 1,1-bis(tert-hexylperoxy)-3,3,5-trimethylcyclohexane, 1,1-bis(tert-hexylperoxy)cyclohexane, 1,1-bis(tert-butylperoxy)-3,3,5-trimethylcyclohexane, 1,1-bis(tert-butylperoxy)-2-methylcyclohexane, 1,1-bis(tert-butylperoxy)-cyclohexane, 2,2-bis(tert-butylperoxy)butane, n-butyl-4,4-bis(tert-butylperoxy)valerate, and 2,2-bis(tert-butylperoxy)octane; hydroperoxides such as p-menthane hydroperoxide, diisopropylbenzene hydroperoxide, 1,1,3,3-tetramethylbutyl hydroperoxide, cumene hydroperoxide, tert-hexyl hydroperoxide, tert-butyl hydroperoxide, 2,5-dimethylhexane-2,5-dihydroperoxide, and 2-(4-methylcyclohexyl)-propane hydroperoxide; dialkyl peroxides such as α,α′-bis(tert-butylperoxy)ₚ-diisopropylbenzene, dicumyl peroxide, 2,5-dimethyl-2,5-bis(tert-butylperoxy)hexane, tert-butylcumyl peroxide, di-tert-butylperoxide, 2,5-dimethyl-2,5-bis(tert-butylperoxy)hexyne-3, and α,α′-bis(tert-butylperoxy)ₚ-isopropylhexyne; diacyl peroxides such as isobutyryl peroxide, 3,3,5-trimethylcyclohexanoyl peroxide, octanoyl peroxide, lauroyl peroxide, stearoyl peroxide, succinic acid peroxide, m-toluoyl peroxide, benzoyl peroxide, acetyl peroxide, decanoyl peroxide, and 2,4-dichlorobenzoyl peroxide; peroxydicarbonates such as di-n-propyl peroxydicarbonate, di-isopropyl peroxydicarbonate, bis-(4-tert-butylcyclohexyl)peroxydicarbonate, di-2-ethoxyethyl peroxydicarbonate, di-2-ethylhexyl peroxydicarbonate, di-3-methoxybutyl peroxydicarbonate, di-sec-butyl peroxydicarbonate, di(3-methyl-3-methoxybutyl)peroxydicarbonate, dimyristyl peroxydicarbonate, di-methoxyisopropyl peroxydicarbonate, and diallyl peroxydicarbonate; peroxyesters such as α,α′-bis(neodecanoperoxy)diisopropylbenzene, cumyl peroxyneodacanoate, 1,1,3,3-tetramethylbutyl peroxyneodecanoate, 1-cyclohexyl-1-methylethyl peroxyneodecanoate, tert-hexyl peroxyneodecanoate, tert-butyl peroxyneodecanoate, tert-hexyl peroxypivalate, tert-butyl peroxypivalate, 1,1,3,3-tetramethylbutyl peroxy-2-ethylhexanoate, 2,5-dibutyl-2,5-bis(2-ethylhexanoylperoxy)hexane, 1-cyclohexyl-1-methylethyl peroxy-2-ethylhexanoate, tert-hexyl peroxy-2-ethylhexanoate, tert-butyl peroxy-2-ethylhexanoate, tert-butyl peroxyisobutyrate, tert-hexyl peroxyisopropyl monocarbonate, tert-butylperoxy maleic acid, tert-butylperoxy-3,5,5-trimethylcyclohexanoate, tert-butyl peroxylaurate, 2,5-dibutyl-2,5-bis(m-toluoylperoxy)hexane, tert-butyl peroxyisopropyl monocarbonate, tert-butylperoxy-2-ethylhexyl monocarbonate, tert-hexyl peroxybenzoate, 2,5-dimethyl-2,5-bis(benzoylperoxy)hexane, tert-butyl peroxy acetate, tert-butyl peroxy-m-toluoylbenzoate, tert-butyl peroxy benzoate, bis(tert-butylperoxy)isophthalate, cumyl peroxy octoate, tert-hexyl peroxy neohexanoate, and cumyl peroxy neohexanoate; other organic peroxides such as tert-butylperoxy allyl carbonate, tert-butyl trimethylsilyl peroxide, and acetylcyclohexyl sulfonyl peroxide. Any one or more of these may be used.

As described above, organic peroxide polymerization initiators whose half-life at 135° C. is 6 to 60 minutes are particularly suitable. The use of polymerization initiators whose half-life period is within the above range further improves the yield of the graft compound.

Examples of organic peroxide polymerization initiators whose half-life at 135° C. is 6 to 60 minutes include t-butylperoxyisopropyl monocarbonate (half-life: 13 minutes), t-hexylperoxyisopropyl monocarbonate (half-life: 6.3 minutes), n-butyl-4,4-di(t-butylperoxy)valerate (half-life: 30 minutes), t-butylperoxybenzoate (half-life: 22 minutes), t-hexylperoxybenzoate (half-life: 15.6 minutes), and 2,5-dimethyl-2,5-di(benzoylperoxy)hexane (half-life: 13.1 minutes).

The amount of organic peroxide polymerization initiator(s) used in the production of the polyalkylene glycol-based polymer of the present invention is not particularly limited and is preferably 1 to 15% by mass, more preferably 2 to 10% by mass, and further more preferably 3 to 7% by mass based on 100% by mass of all the monomers (the polyalkylene glycol-based compound, the carboxyl group-containing monomer and other monomers). If too little polymerization initiators are used, the yield of the graft compound obtained by graft polymerization of the monomer material on the polyoxyalkylene chain will be low. If too much polymerization initiators are used, problems such as high production cost will occur and performance of the resulting polymer will be low.

When the polyalkylene glycol-based polymer of the present invention is intended to be used for detergents and the like, polymerization initiators free from aromatic rings are preferable, considering influence on the environment. If a polymerization initiator having an aromatic ring is used, a small amount of an aromatic compound such as benzene may remain in the polyalkylene glycol-based polymer composition. For this reason, t-butylperoxyisopropyl monocarbonate, t-hexylperoxyisopropyl monocarbonate, and n-butyl 4,4-di(t-butylperoxy)valerate are particularly preferable among the above examples of the organic peroxide polymerization initiators.

The polymerization initiator(s) may be added in any manner in the production of the polyalkylene glycol-based polymer of the present invention. It is preferable to add the polymerization initiator(s) simultaneously with the monomer material and not to mix the polymerization initiator(s) with polyalkylene glycol-based compound in advance.

In the graft polymerization, other compounds such as a catalyst for decomposing the polymerization initiator(s) and a reducing compound may be added in the reaction system in addition to the above-mentioned polymerization initiator(s). Examples of catalysts for decomposing the polymerization initiator(s) include halogenated metals such as lithium chloride and lithium bromide; metal oxides such as titanium oxide and silica dioxide; metal salts of inorganic acids such as hydrochloric acid, hydrobromic acid, perchloric acid, sulfuric acid, and nitric acid; carboxylic acids such as formic acid, acetic acid, propionic acid, butyric acid, isobutyric acid, and benzoic acid, and esters and metal salts thereof; heterocyclic amines such as pyridine, indole, imidazole, and carbazole, and derivatives thereof. Any of these decomposition catalysts may be used alone, or two or more of these may be used in combination.

Examples of reducing compounds include organic metal compounds such as ferrocene; inorganic compounds capable of generating metal ions (e.g. iron, copper, nickel, cobalt, manganese ions) such as iron naphthenate, copper naphthenate, nickel naphthenate, cobalt naphthenate, and manganese naphthenate; inorganic compounds such as ether adducts of boron trifluoride, potassium permanganate, and perchloric acid; sulfur-containing compounds such as sulfur dioxide, sulfites, sulfates, bisulfites, thiosulfates, sulfoxylates, benzene sulfinic acid and substituted compounds thereof, and analogues of cyclic sulfinic acid such as p-toluene sulfinic acid; mercapto compounds such as octyl mercaptan, dodecyl mercaptan, mercapto ethanol, α-mercaptopropionic acid, thioglycolic acid, thiopropionic acid, sodium α-thiopropionate sulfopropylester, and sodium α-thiopropionate sulfoethylester; nitrogen-containing compounds such as hydrazine, β-hydroxyethylhydrazine, and hydroxylamine; aldehydes such as formaldehyde, acetaldehyde, propionaldehyde, n-butylaldehyde, isobutylaldehyde, and isovalerianaldehyde; and ascorbic acid. Any of these reducing compounds may be used alone, or two or more of these may be used in combination. Some of the reducing compounds including mercapto compounds can be used as chain transfer agents.

In the production process of the polyalkylene glycol-based polymer of the present invention, solvent(s) preferably constitute not more than 10% by mass, more preferably not more than 7% by mass, further more preferably not more than 5% by mass, and still further more preferably not more than 3% by mass of the whole reaction system. Particularly preferably, the reaction system is substantially free from solvent(s). The term “substantially free from solvent(s)” means that any solvents are not intentionally added for the polymerization, and that solvents may be contained at low levels as impurities.

In the case that the reaction system contains solvent(s), the solvent(s) are not particularly limited, and preferred examples thereof include solvents with a low chain transfer constant to the monomer material, and solvents that have a boiling point of not lower than 70° C. and can be used at ambient pressure. Examples of such solvents include alcohols such as isobutyl alcohol, n-butyl alcohol, tert-butyl alcohol, isopropyl alcohol, ethylene glycol, diethylene glycol, glycerin, triethylene glycol, propylene glycol, ethylene glycol monoalkyl ethers, and propylene glycol monoalkyl ethers; diethers such as ethylene glycol dialkyl ethers and propylene glycol dialkyl ethers; acetic acid-based compounds such as acetic acid, ethyl acetate, propyl acetate, butyl acetate, acetates of ethylene glycol monoalkyl ethers, and acetates of propylene glycol monoalkyl ethers. Any of these solvents may be used alone, or two or more of these may be used in combination. Examples of alkyl groups in the alcohols and diethers include methyl group, ethyl group, propyl group, and butyl group.

The polymerization temperature of the polyalkylene glycol-based polymer of the present invention is preferably not lower than 100° C., more preferably 100° C. to 160° C., further more preferably 110° C. to 150° C., and still further more preferably 130° C. to 140° C. At too low polymerization temperatures, the viscosity of the reaction liquid will be too high, which may result in a difficulty in the progress of the graft polymerization and a reduction in the degree of grafting of the monomer material. At too high polymerization temperatures, the polyalkylene glycol-based compound and the resulting polymer may be pyrolyzed. In addition, the monomers and initiators may volatilize. The polymerization temperature is not necessarily kept substantially constant throughout the polymerization, and the temperature may be set at room temperature at the start of the polymerization reaction, increased to a set temperature at an appropriate temperature rising rate or over an appropriate temperature rising time, and then kept at the set temperature. Alternatively, the polymerization temperature may be altered (increased or decreased) with a lapse of time during the polymerization reaction depending on the drop-wise addition method for the monomers, initiator, and the like.

The polymerization time in the production of the polyalkylene glycol-based polymer of the present invention is not particularly limited, and is preferably 30 to 420 minutes, more preferably 45 to 390 minutes, further more preferably 60 to 360 minutes, and still further more preferably 90 to 240 minutes. In the present invention, the reaction is preferably carried out while the monomer material is consecutively added. The term “polymerization time” used herein means a time in which the monomers are being added, that is, a time from the start to the end of addition of the monomers.

The pressure in the reaction system in the production process of the present invention may be any of normal pressure (atmospheric pressure), reduced pressure, and increased pressure. Considering the molecular weight of the resulting copolymer, it is preferable that the reaction is preferably carried out under normal pressure, or that the reaction system is sealed and the reaction is carried out under increased pressure. Considering equipment such as pressuring or depressurizing devices, a pressure-resistant reaction vessel, and pipes, normal pressure (atmospheric pressure) is preferable. The atmosphere in the reaction system may be air atmosphere but is preferably an inert gas atmosphere. It is preferable, for example, to replace the air in the system with an inert gas such as nitrogen before the start of polymerization.

In the production process of the present invention, before the start of polymerization, portion or the whole of the polyalkylene glycol-based compound is preferably charged in the reaction system. For example, polymerization may be carried out by charging the whole amount of the polyalkylene glycol-based compound in the reaction system, increasing the temperature in the reaction system, and separately adding the monomer material and polymerization initiators. Such a process is preferable because graft polymerization is likely to smoothly proceed and the molecular weight of the resulting polymer can be easily controlled. Polymerization may be batchwise polymerization or continuous polymerization.

### [Usage of Polymer and Polymer Composition]

The polyalkylene glycol-based polymer of the present invention (or polyalkylene glycol-based polymer composition) can be used as a coagulant, flocculating agent, printing ink, adhesive, soil control (modification) agent, fire retardant, skin care agent, hair care agent, additive for shampoos, hair sprays, soaps, and cosmetics, anion exchange resin, dye mordant, and auxiliary agent for fibers and photographic films, pigment spreader for paper making, paper reinforcing agent, emulsifier, preservative, softening agent for textiles and paper, additive for lubricants, water treatment agent, fiber treating agent, dispersant, additive for detergents, scale control agent (scale depressant), metal ion sealing agent, viscosity improver, binder of any type, emulsifier, and the like. When used as a detergent builder, the polyalkylene glycol-based polymer of the present invention (or polyalkylene glycol-based polymer composition) can be added to detergents for various usages such as detergents for clothes, tableware, cleaning, hair, bodies, toothbrushing, and vehicles.

### <Water Treatment Agent>

The polyalkylene glycol-based polymer of the present invention (or polyalkylene glycol-based polymer composition) can be used in water treatment agents. When used in water treatment agents, the polyalkylene glycol-based polymer of the present invention (or polyalkylene glycol-based polymer composition) may be provided as a composition formulated with polyphosphates, phosphates, anti-corrosion agents, slime control agents, and chelating agents, if necessary.

Such water treatment agents are useful for scale inhibition of cooling water circulation systems, boiler water circulation systems, seawater desalination plants, pulp digesters, black liquor condensing kettles and the like. In addition, any suitable water soluble polymer may be included within a range of not affecting the performance or effect of this polymer.

### <Fiber Treating Agent>

The polyalkylene glycol-based polymer of the present invention (or polyalkylene glycol-based polymer composition) can be used in fiber treating agents. Such fiber treating agents contain the polyalkylene glycol-based polymer of the present invention (or polyalkylene glycol-based polymer composition) and at least one selected from the group consisting of dyeing agents, peroxides, and surfactants.

In fiber treating agents, the polyalkylene glycol-based polymer of the present invention preferably constitutes 1 to 100% by weight, and more preferably 5 to 100% by weight of the total amount. In addition, any suitable water soluble polymer may be included within a range of not affecting the performance or effect of this polymer.

An example of the composition of such a fiber treating agent is described below. The fiber treating agent can be used in steps of scouring, dyeing, bleaching and soaping in fiber treatment. Examples of dyeing agents, peroxides, and surfactants include those commonly used in fiber treating agents.

The blending ratio between the polyalkylene glycol-based polymer of the present invention and at least one selected from the group consisting of dyeing agents, peroxides, and surfactants is determined based on the amount of the purity converted fiber treating agent per part by weight of the polymer of the present invention. In a suitable example of a composition that is used as a fiber treating agent to provide improved degree of whiteness, color uniformity, and dyeing fastness of textiles, at least one selected from the group consisting of dyeing agents, peroxides, and surfactants is preferably used at a ratio of 0.1 to 100 parts by weight per part by weight of the polyalkylene glycol-based polymer of the present invention.

The fiber treating agent can be used for any suitable fibers including cellulosic fibers such as cotton and hemp, synthetic fibers such as nylon and polyester, animal fibers such as wool and silk thread, semisynthetic fibers such as rayon, and textiles and mixed products of these.

For a fiber treating agent used in a scouring step, an alkali agent and a surfactant are preferably used with the polyalkylene glycol-based polymer of the present invention. For a fiber treating agent used in a bleaching step, a peroxide and a silicic acid-containing agent such as sodium silicate as a decomposition inhibitor for alkaline bleaches are preferably used with the polyalkylene glycol-based polymer of the present invention.

### <Inorganic Pigment Dispersant>

The polyalkylene glycol-based polymer of the present invention (or polyalkylene glycol-based polymer composition) can be used in inorganic pigment dispersants. When used in inorganic pigment dispersants, the polyalkylene glycol-based polymer of the present invention (or polyalkylene glycol-based polymer composition) may be provided as a composition formulated with condensed phosphoric acid and salts thereof, phosphoric acid and salts thereof, and polyvinyl alcohol, if necessary.

In inorganic pigment dispersants, the polyalkylene glycol-based polymer of the present invention preferably constitutes 5 to 100% by weight of the total amount. In addition, any suitable water soluble polymer may be included within a range of not affecting the performance or effect of this polymer.

Such inorganic pigment dispersants produce good performance as inorganic pigment dispersants for heavy or light calcium carbonate and clay used for paper coating. For example, by adding such an inorganic pigment dispersing agent in a small amount to inorganic pigments and dispersing them into water, a highly concentrated inorganic pigment slurry such as a high concentrated calcium carbonate slurry having low viscosity, high fluidity, and excellent temporal stability of these properties can be produced.

When such an inorganic pigment dispersant is used as a dispersant for inorganic pigments, the amount of the inorganic pigment dispersant is preferably 0.05 to 2.0 parts by weight per 100 parts by weight of pigments. The use of the inorganic pigment dispersant in an amount within the above range provides a sufficient dispersion effect proportional to the added amount and is advantageous in terms of cost.

### <Detergent Builder>

The polyalkylene glycol-based polymer of the present invention (or polyalkylene glycol-based polymer composition) can be also used as a detergent builder. The detergent builder can be added to detergents for various usages such as detergents for clothes, tableware, cleaning, hair, bodies, toothbrushing, and vehicles.

### <Detergent Composition>

The polyalkylene glycol-based polymer of the present invention (or polyalkylene glycol-based polymer composition) can be also used in detergent compositions.

In detergent compositions, the amount of the polyalkylene glycol-based polymer is not particularly limited, and the polyalkylene glycol-based polymer is preferably used at a level of 0.1 to 15% by mass, more preferably 0.3 to 10% by mass, and further more preferably 0.5 to 5% by mass of the total amount. At levels within this range, the polyalkylene glycol-based polymer provides excellent detergent builder performance.

Detergent compositions used for washing typically contain surfactants and additives which are commonly used in detergents. Such surfactants and additives are not particularly limited and are appropriately selected based on common knowledge in the field of detergents. The detergent compositions may be in the form of a powder or liquid.

One or more surfactants selected from the group consisting of anionic surfactants, nonionic surfactants, cationic surfactants, and amphoteric surfactants are used.

When two or more of them are used in combination, the total amount of anionic surfactant(s) and nonionic surfactant(s) is preferably not less than 50% by mass, more preferably not less than 60% by mass, further more preferably not less than 70% by mass, and still further more preferably not less than 80% by mass of all the surfactants.

Suitable examples of anionic surfactants include alkylbenzene sulfonates, alkylether sulfates, alkenylether sulfates, alkyl sulfates, alkenyl sulfates, α-olefinsulfonates, α-sulfo fatty acids and α-sulfo fatty acid ester salts, alkane sulfonates, saturated fatty acid salts, unsaturated fatty acid salts, alkylether carboxylates, alkenylether carboxylates, amino acid-type surfactants, N-acylamino acid-type surfactants, alkyl phosphates and salts of these, and alkenyl phosphates and salts of these. The alkyl groups or alkenyl groups in these anionic surfactants may have alkyl side groups such as methyl side group.

Suitable examples of nonionic surfactants include polyoxyalkylene alkyl ethers, polyoxyalkylene alkenyl ethers, polyoxyethylene alkyl phenyl ethers, higher-fatty-acid alkanol amides and alkylene oxide adducts thereof, sucrose fatty acid esters, alkyl glycoxydes, fatty acid glycerin monoesters, and alkylamine oxides. The alkyl groups or the alkenyl groups in these nonionic surfactants may have alkyl side groups such as methyl side group.

Suitable examples of cationic surfactants include quaternary ammonium salts. Preferred examples of amphoteric surfactants include carboxyl-type amphoteric surfactants, and sulfobetaine-type amphoteric surfactants. The alkyl groups or the alkenyl groups in these cationic surfactants and amphoteric surfactants may have alkyl side groups such as methyl side group.

In detergent compositions, these surfactants are typically present at a level of 10 to 60% by mass of the total amount, and are preferably present at a level of 15 to 50% by mass, more preferably at a level of 20 to 45% by mass, and further more preferably at a level of 25 to 40% by mass. The use of surfactants at a too small level may result in insufficient washing performance, and the use of surfactants at a too high level is disadvantageous in terms of cost.

Suitable examples of additives include alkali builders, chelate builders, anti redeposition agents for preventing redeposition of contaminants such as sodium carboxymethylcellulose, stain inhibitors such as benzotriazole and ethylenethiourea, soil release agents, color migration inhibitors, softening agents, alkaline substances for pH adjustment, perfumes, solubilizing agents, fluorescent agents, coloring agents, foaming agents, foam stabilizers, lustering agents, bactericides, bleaching agents, bleaching assistants, enzymes, dyes, and solvents. Powder detergent compositions preferably contain zeolite.

These detergent compositions may contain other detergent builders in addition to the polyalkylene glycol-based polymer of the present invention (or polyalkylene glycol-based polymer composition). Examples of other detergent builders are not particularly limited and include alkali builders such as carbonates, hydrogencarbonates, and silicates; chelate builders such as tripolyphosphates, pyrophosphates, Glauber's salt, nitrilotriacetates, ethylene diamine tetraacetates, citrates, salts of (meth)acrylic acid copolymers, acrylic acid-maleic acid copolymers, fumarates, and zeolite; and carboxyl derivatives of polysaccharides such as carboxymethyl cellulose. Examples of counter salts used with these builders include alkaline metals such as sodium and potassium, ammonium, and amines.

Typically, in the detergent compositions, the above additives and other detergent builders are preferably present at a level of 0.1 to 50% by mass based on 100% by mass of the total amount. The level is more preferably 0.2 to 40% by mass, further more preferably 0.3 to 35% by mass, still further more preferably 0.4 to 30% by mass, and particularly preferably 0.5 to 20% by mass. The use of the additives and other builders at a level of less than 0.1% by mass may result in insufficient washing performance, and the use of the additives and other builders at a level of more than 50% by mass is disadvantageous in terms of cost.

It is to be understood that the concept of the “detergent compositions” includes detergents used only for specific usages such as bleaching detergent in which the performance delivered by one component is improved, in addition to synthetic detergents of household detergents, detergents for industrial use such as detergents used in the textile industry and hard surface detergents.

When the detergent compositions are in the form of a liquid, the water content of the liquid detergent compositions is typically preferably 0.1 to 75% by mass, more preferably 0.2 to 70% by mass, further more preferably 0.5 to 65% by mass, still further more preferably 0.7 to 60% by mass, particularly preferably 1 to 55% by mass, and more particularly preferably 1.5 to 50% by mass based on the total mass of the liquid detergent composition.

When the detergent compositions are in the form of a liquid, the kaolin turbidity of the detergent compositions is preferably not more than 200 mg/L, more preferably not more than 150 mg/L, further more preferably not more than 120 mg/L, still further more preferably not more than 100 mg/L, and particularly preferably not more than 50 mg/L.

### <Method for Measuring Kaolin Turbidity>

A uniformly stirred sample (liquid detergent) is charged in 50 mm square cells with a thickness of 10 mm, and bubbles are removed therefrom. Then, the sample is measured for turbidity (kaolin turbidity: mg/L) at 25° C. with a turbidimeter (trade name: NDH2000, product of Nihon Denshoku Industries Co., Ltd.).

Suitable examples of enzymes that can be mixed in the detergent compositions include proteases, lipases, and cellulases. Among these, proteases, alkali lipases, and alkali cellulases are preferable because of their high activity in alkali-washing liquids.

In the detergent compositions, the enzymes are preferably used at a level of not more than 5% by mass based on 100% by mass of the total amount. The use of more than 5% by mass of the enzymes will not improve the washing performance and may be disadvantageous in cost.

Suitable examples of alkali builders include silicates, carbonates, and sulfates. Suitable examples of the chelate builders include diglycollic acid, oxycarboxylates, EDTA (ethylenediaminetetraacetic acid), DTPA (diethylenetriamine pentaacetic acid), STPP (sodiumtripolyphosphate), and citratic acid. Water-soluble polycarboxylic acid-based polymers other than the polymer of the present invention may be used.

The detergent compositions have high dispersability and are less likely to show performance deterioration even when stored for a long period, or to generate precipitation of impurities even when stored at low temperature. Therefore, the use of the detergent compositions provides detergents with strikingly high performance and stability.

### Effects of the Invention

The polyalkylene glycol-based polymer of the present invention is designed as described above and has high anti-soil redeposition ability and compatibility with surfactants in washing treatment, particularly in aqueous environment. Owing to these properties, the polyalkylene glycol-based polymer of the present invention can be suitably used as a raw material for detergent additives and the like.

### BEST MODE FOR CARRYING OUT THE INVENTION

Hereinafter, the present invention is described in more detail based on examples, but is not limited only to these examples. All parts are by weight unless otherwise specified, and all percentages are by mass unless otherwise specified.

The weight average molecular weight of the polyalkylene glycol-based polymer of the present invention, the solids contents of polymer compositions and polymerization aqueous solutions, and the yield of the graft polymer were determined by the methods shown below.

### <Measurement Condition of Weight Average Molecular Weight (GPC)>

Measuring device: L-7000 series (product of Hitachi Ltd.)

Detector: HITACHI RI Detector, L-7490

Column: SHODEX Asahipak GF-310-HQ, GF-710-HQ, GF-1G 7B

(products of Showa Denko K. K.)

Column temperature: 40° C.

Flow velocity: 0.5 mL/min

Calibration curve: POLYETHYLENE GLYCOL STANDARD (product of GL Sciences, Inc.)

Eluant: 0.1 N sodium acetate/acetonitrile=3/1 (mass ratio)

### <Qualitative Analysis of Carboxyl Group-Containing Monomer and Other Compound>

The carboxyl group-containing monomer and other compounds were quantified by liquid chromatography under the following conditions.

Measuring device: L-7000 series (product of Hitachi Ltd.)

Detector: UV detector, L-7400 (product of Hitachi Ltd.)

Column: SHODEX RSpak DE-413 (product of Showa Denko K. K.)

Temperature: 40.0° C.

Eluant: 0.1% phosphoric acid aqueous solution

Flow velocity: 1.0 ml/min

### <Measurement of Solids Content of Polymer Composition>

A polymer composition (polymer composition (1.0 g)+water (3.0 g)) was left in an oven heated to 130° C. in nitrogen atmosphere for one hour so as to be dried. The solids content (%) and volatile component content (%) were calculated from the weight change before and after the drying step.

### <Measurement of Yield of Graft Polymer>

The graft polymer content (% by mass) of the polymer composition (based on solids content) is defined as the yield of the graft compound, that is, the ratio of the mass of the graft polymer contained in the polymer composition to the mass of the solids content of the polymer composition. The graft polymer content of the polymer composition is calculated by the following formula:

graft polymer content (% by mass) of polymer composition (based on solids content)=100 (%)−(unreacted polyoxyalkylene glycol-based compound content of polymer composition (%)+acid group-containing unsaturated monomer content of polymer composition (based on solids content) (%)+compound (1), (2), (3) content in the sold matter of polymer composition (%) (based on solids content)+polymer made of only acid group-containing unsaturated monomer content of polymer composition (%) (based on solids content))

The polymers made of only acid group-containing unsaturated monomers were quantified by capillary electrophoresis under the following conditions.

### <Condition of Electrophoretic Analysis>

Measuring device: CAPILLARY ELECTROPHORESIS SYSTEM CAPI-3300 (product of Photal OTSUKA ELECTRONICS)

Voltage: 15 kV

Developing solvent: 50 mmol/L sodium 4-borate aqueous solution

Electrophoresis run time: 30 minutes

Detector: UV 210 nm

### Example 1

In a 500-mL glass separable flask equipped with a stirrer (paddle blade), ethylene oxide 20 mol adduct of propylene oxide-5 mol adduct of methanol (86.0 g) was charged and stirred with nitrogen flowing into the flask while heating to 120° C. The flask was kept 120° C. and stirred with nitrogen flowing for one hour to dehydrate the reaction system. Next, a reflux condenser was attached to the flask and the reaction system was heated to 135° C. To the reaction system, 100% acrylic acid (hereinafter, also referred to as “AA”) (9.6 g) and t-butylperoxy isopropyl monocarbonate (hereinafter, also referred to as PBI) (525 μL (0.48 g, 5.0% by mass to AA) as a polymerization initiator were separately added dropwise through different nozzles. The drop-wise addition times of PBI and AA were both 260 minutes. The addition of AA was started 10 minutes after the start of addition of PBI. Each solution was continuously added dropwise at a constant rate.

After the completion of drop-wise addition of AA, the reaction liquid was maintained (matured) at 135° C. for more 60 minutes and the polymerization was completed (polyalkylene glycol-based polymer (1) of the present invention). After the completion of polymerization, the polymerization reaction liquid was cooled under stirring while pure water (24.0 g) was added to dilute the polymerization reaction liquid.

Thus, an 80% aqueous solution (solids concentration (mass)) (polymer composition (1)) was provided.

### Example 2

In a 500-mL glass separable flask equipped with a stirrer (paddle blade), ethylene oxide 20 mol adduct of propylene oxide-5 mol adduct of methanol (75.6 g) was charged and stirred with nitrogen flowing into the flask while heating to 120° C. The flask was kept 120° C. and stirred with nitrogen flowing for one hour to dehydrate the reaction system. Next, a reflux condenser was attached to the flask and the reaction system was heated to 135° C. To the reaction system, AA (8.4 g) and PBI (525 μL (0.42 g, 5.0% by mass to AA) as a polymerization initiator were separately added dropwise through different nozzles. The drop-wise addition times of PBI and AA were both 210 minutes. The addition of AA was started 20 minutes after the start of addition of PBI. Each solution was continuously added dropwise at a constant rate.

After the completion of drop-wise addition of AA, the reaction liquid was maintained (matured) at 135° C. for more 60 minutes and the polymerization was completed (polyalkylene glycol-based polymer (2) of the present invention). After the completion of polymerization, the polymerization reaction liquid was cooled under stirring while pure water (21.1 g) was added to dilute the polymerization reaction liquid.

Thus, an 80% aqueous solution (solids concentration (mass)) (polymer composition (2)) was provided.

### Example 3

In a 500-mL glass separable flask equipped with a stirrer (paddle blade), ethylene oxide 20 mol adduct of propylene oxide-5 mol adduct of methanol (114.7 g) was charged and stirred with nitrogen flowing into the flask while heating to 120° C. The flask was kept 120° C. and stirred with nitrogen flowing for one hour to dehydrate the reaction system. Next, a reflux condenser was attached to the flask and the reaction system was heated to 135° C. To the reaction system, AA (28.7 g) and PBI (1575 μL (0.42 g, 5.0% by mass to AA) as a polymerization initiator were separately added dropwise through different nozzles. The drop-wise addition times of PBI and AA were both 210 minutes. The addition of AA was started 20 minutes after the start of addition of PBI. Each solution was continuously added dropwise at a constant rate.

After the completion of drop-wise addition of AA, the reaction liquid was maintained (matured) at 135° C. for more 60 minutes and the polymerization was completed (polyalkylene glycol-based polymer (3) of the present invention). After the completion of polymerization, the polymerization reaction liquid was cooled under stirring while pure water (36.2 g) was added to dilute the polymerization reaction liquid.

Thus, an 80% aqueous solution (solids concentration (mass)) (polymer composition (3)) was provided.

### Example 4

In a 500-mL glass separable flask equipped with a stirrer (paddle blade), ethylene oxide 30 mol adduct of propylene oxide-5 mol adduct of methanol (75.6 g) was charged and stirred with nitrogen flowing into the flask while heating to 120° C. The flask was kept 120° C. and stirred with nitrogen flowing for one hour to dehydrate the reaction system. Next, a reflux condenser was attached to the flask and the reaction system was heated to 135° C. To the reaction system, AA (8.4 g) and t-butylperoxy benzoate (hereinafter, also referred to as PBZ (525 μL (0.42 g, 5.0% by mass to AA) as a polymerization initiator were separately added dropwise through different nozzles. The drop-wise addition times of PBZ and AA were both 210 minutes. The addition of AA was started 20 minutes after the start of addition of PBZ. Each solution was continuously added dropwise at a constant rate.

After the completion of drop-wise addition of AA, the reaction liquid was maintained (matured) at 135° C. for more 60 minutes and the polymerization was completed (polyalkylene glycol-based polymer (4) of the present invention). After the completion of polymerization, the polymerization reaction liquid was cooled under stirring while pure water (21.1 g) was added to dilute the polymerization reaction liquid.

Thus, an 80% aqueous solution (solids concentration (mass)) (polymer composition (4)) was provided.

### Example 5

In a 500-mL glass separable flask equipped with a stirrer (paddle blade), ethylene oxide 30 mol adduct of propylene oxide-10 mol adduct of methanol (75.6 g) was charged and stirred with nitrogen flowing into the flask while heating to 120° C. The flask was kept 120° C. and stirred with nitrogen flowing for one hour to dehydrate the reaction system. Next, a reflux condenser was attached to the flask and the reaction system was heated to 135° C. To the reaction system, AA (8.4 g) and PBI (525 μL (0.42 g, 5.0% by mass to AA) as a polymerization initiator were separately added dropwise through different nozzles. The drop-wise addition times of PBI and AA were both 210 minutes. The addition of AA was started 20 minutes after the start of addition of PBI. Each solution was continuously added dropwise at a constant rate.

After the completion of drop-wise addition of AA, the reaction liquid was maintained (matured) at 135° C. for more 60 minutes and the polymerization was completed (polyalkylene glycol-based polymer (5) of the present invention). After the completion of polymerization, the polymerization reaction liquid was cooled under stirring while pure water (21.1 g) was added to dilute the polymerization reaction liquid.

Thus, an 80% aqueous solution (solids concentration (mass)) (polymer composition (5)) was provided.

### Comparative Example 1

In a 500-mL glass separable flask equipped with a stirrer (paddle blade), ethylene oxide 25 mol adduct of methanol (105.6 g) was stirred with nitrogen flowing into the flask while heating to 120° C. The flask was kept 120° C. and stirred with nitrogen flowing for one hour to dehydrate the reaction system. Next, a reflux condenser was attached to the flask and the reaction system was heated to 128° C. To the reaction system, AA (11.7 g) and PBI (1125 μL (1.17 g, 10.0% by mass to AA) as a polymerization initiator were separately added dropwise through different nozzles. The drop-wise addition times of PBI and AA were 150 minutes and 240 minutes, respectively. The addition of AA was started 20 minutes after the start of addition of PBI. Each solution was continuously added dropwise at a constant rate.

After the completion of drop-wise addition of AA, the reaction liquid was maintained (matured) at 128° C. for more 60 minutes and the polymerization was completed (comparative polyalkylene glycol-based polymer (1)). After the completion of polymerization, the polymerization reaction liquid was cooled under stirring while pure water (13.2 g) was added to dilute the polymerization reaction liquid.

Thus, a 90% aqueous solution (solids concentration (mass)) (comparative polymer composition (1)) was provided.

The copolymer compositions (1) to (6) were analyzed by liquid chromatography to determine the amounts of the residual monomers, and the results revealed that the total amount of the residual monomers was less than 100 ppm in each composition.

The polymer compositions (1) to (5) prepared in Examples 1 to 5 and the comparative polymer composition (1) prepared in Comparative Example (1) were evaluated as follows. Table 1 shows the results.

### <Anti-Soil Redeposition Ability Test/Carbon Black>

(1) Polyester cloth available from Test fabric was cut into 5 cm×5 cm white clothes. The degree of whiteness was determined for the white clothes by measuring the reflectance with a colorimetric color difference meter (SE2000, product of Nippon Denshoku Industries Co., Ltd.).

(2) Pure water was added to calcium chloride dihydrate (5.88 g) such that hard water (20 kg) was prepared.

(3) Pure water was added to sodium linear alkylbenzene sulfonate (8.0 g), sodium bicarbonate (9.5 g), and sodium sulfate (8.0 g) such that a surfactant aqueous solution (100.0 g) was prepared. The pH was controlled to 10.

(4) A targotmeter was set at 25° C. Hard water (2 L), the surfactant aqueous solution (5 g), 0.8% (based on solids content) polymer aqueous solution (5 g), zeolite (0.30 g), and carbon black (0.50 g) were stirred for one minute in a pot at 100 rpm. Subsequently, seven white cloths were put into the mixture, and the mixture was stirred for ten minutes at 100 rpm.

(5) The white cloths were wringed by hand, and the hard water (2 L) at 25° C. was poured into the pot and stirred at 100 rpm for two minutes.

(6) The white clothes were ironed with a cloth thereon to dry them while wrinkles were smoothed. The clothes were measured again for reflectance as whiteness with the colorimetric difference meter.

(7) The anti-soil redeposition ratio was determined from the following formula, based on the measurement results.

Anti-soil redeposition ratio (%)=(whiteness of white cloth after washed)/(whiteness of original white cloth)×100

<Compatibility with Surfactant>

Detergent compositions each containing a test sample (polymer or polymer composition) were prepared using the following materials.

SFT-70H (polyoxyethylene alkyl ether, product of NIPPON SHOKUBAI Co., Ltd.): 40 g

NEOPELEX F-65 (sodium dodecylbenzene sulfonate, product of Kao Corp.): 7.7 g (active ingredient: 5 g)

Kohtamin 86W (stearyl trimethylammonium chloride, product of Kao Corp.): 17.9 g (active ingredient: 5 g)

Diethanolamine: 5 g

Ethanol: 5 g

Propylene glycol: 5 g

Test sample: 1.5 g (based on solids content)

Ion exchange water: the amount of ion exchange water was appropriately adjusted such that the total amount of the detergent composition was 100 g based on the amount of the test sample.

The mixture was sufficiently stirred so that all the components were uniformly dispersed. Turbidity of the mixture was evaluated by Turbidity (kaolin turbidity, mg/l) measured at 25° C. with a turbidimeter (“NDH2000”, product of Nippon Denshoku Co., Ltd.).

The evaluation was based on the following criteria:

Good: Kaolin turbidity of not less than 0 and less than 50 (mg/l); phase separation, sedimentation, and turbidity were not visually observed.

Intermediate: Kaolin turbidity of not less than 50 and less than 200 (mg/l); slight turbidity was visually observed.

Bad: Kaolin turbidity of not less than 200 (mg/l); turbidity was visually observed.

TABLE 1

| | | | | | | | Yield of | | Anti-soil |
|---|---|---|---|---|---|---|---|---|---|
| | | | | PEG/ | Polymerization | | graft | | redeposition |
| | Polymer | PO | EO | Acid | initator | Mw | polymer (%) | Compatibility | ratio (%) |
| Example 1 | Polymer composition (1) | 5 | 20 | 90/10 | PBI | 1,700 | 55 | Good | 68.2 |
| Example 2 | Polymer composition (2) | 5 | 20 | 90/10 | PBI | 2,000 | 40 | Good | 69.3 |
| Example 3 | Polymer composition (3) | 5 | 20 | 80/20 | PBI | 3,200 | 77 | Good | 70.2 |
| Example 4 | Polymer composition (4) | 5 | 30 | 90/10 | PBZ | 2,200 | 62 | Good | 66.6 |
| Example 5 | Polymer composition (5) | 10 | 30 | 90/10 | PBI | 2,400 | 60 | Good | 68.8 |
| Comparative | Comparative polymer | 0 | 25 | 90/10 | PBI | 1,900 | 53 | Good | 51.4 |
| Example 1 | composition (1) | | | | | | | | |

The results in Table 1 show high compatibility with surfactants and high anti-soil redeposition ability of the polyalkylene glycol-based polymer of the present invention and therefore suggest that the polyalkylene glycol-based polymer of the present invention can be suitably used as a raw material for detergent additives and the like.

1. A polyalkylene glycol-based polymer comprising a plurality of added oxyalkylene groups,
the polyalkylene glycol-based polymer obtained by polymerizing a polyalkylene glycol-based compound having a structure unit including the oxyalkylene groups at or near a terminal of a molecule and a monomer material including a carboxyl group-containing monomer, in the presence of t-butylperoxyisopropyl monocarbonate, t-hexylperoxyisopropyl monocarbonate or n-butyl 4,4-di(t-butylperoxy)valerate as a polymerization initiator and under the condition that a mass ratio between the polyalkylene glycol-based compound and the carboxyl group-containing monomer is (95:5) to (60:40),
wherein the structure unit including the oxyalkylene groups is represented by the following formula (1); 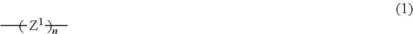
in the formula (1), each of Z¹s represents a C₃₋₄ oxyalkylene group and may be the same as or different from each other; and n represents an average addition number of moles of the oxyalkylene groups (—Z¹—) and is from 3 to 30; and wherein the polyalkylene glycol-based polymer is a graft polymer in which polymer chains derived from the carboxyl group-containing monomer are linked to carbon atoms in the polyoxyalkylene chain of the polyalkylene glycol-based compound and has C₂₋₂₀ oxyalkylene group other than the C₃₋₄ oxyalkylene group, in addition to the structure unit represented by the formula (1).

2. A process for producing a polyalkylene glycol-based polymer comprising a plurality of added oxyalkylene groups,
the process comprising polymerizing a polyalkylene glycol-based compound having a structure unit including the oxyalkylene groups at or near a terminal of a molecule and a monomer material including a carboxyl group-containing monomer, in the presence of t-butylperoxyisopropyl monocarbonate, t-hexylperoxyisopropyl monocarbonate or n-butyl 4,4-di(t-butylperoxy)valerate as a polymerization initiator and under the condition that a mass ratio between the polyalkylene glycol-based compound and the carboxyl group-containing monomer is (95:5) to (60:40),
wherein the structure unit including the oxyalkylene groups is represented by the following formula (1); 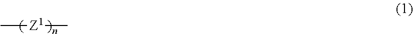
in the formula (1), each of Z¹s represents a C₃₋₄ oxyalkylene group and may be the same as or different from each other; and n represents an average addition number of moles of the oxyalkylene groups (—Z¹—) and is from 3 to 30; and wherein the polyalkylene glycol-based polymer is a graft polymer in which polymer chains derived from the carboxyl group-containing monomer are linked to carbon atoms in the polyoxyalkylene chain of the polyalkylene glycol-based compound and has C₂₋₂₀ oxyalkylene group other than the C₃₋₄ oxyalkylene group, in addition to the structure unit represented by the formula (1).

3. The polyalkylene glycol-based polymer according to claim 1, wherein the polyalkylene glycol-based polymer is obtained by using an organic peroxide polymerization initiator whose half-life at 135° C. is 6 to 60 minutes.

4. The polyalkylene glycol-based polymer according to claim 1, wherein the C₂₋₂₀ oxyalkylene group other than the C₃₋₄ oxyalkylene group is an oxyethylene group.

5. The process for producing a polyalkylene glycol-based polymer according to claim 2, wherein polymerizing the polyalkylene glycol-based compound and the monomer material including a carboxyl group-containing monomer is carried out in the presence of an organic peroxide polymerization initiator whose half-life at 135° C. is 6 to 60 minutes.

6. The process for producing a polyalkylene glycol-based polymer according to claim 2, wherein the C₂₋₂₀ oxyalkylene group other than the C₃₋₄ oxyalkylene group is an oxyethylene group.

7. The process for producing a polyalkylene glycol-based polymer according to claim 2, wherein the amount of said polymerization initiator is 1 to about 15% by mass based on all of the total of all of the monomers of said polyalkylene glycol-based polymer.

8. The polyalkylene glycol-based polymer according to claim 1, wherein the amount of said polymerization initiator is 1 to about 15% by mass based on all of the total of all of the monomers of said polyalkylene glycol-based polymer.
